(19) United States
(12) Patent Application Publication
(10) Pub. No.: US 2003/0187626 A1
(43) Pub. Date: Oct. 2, 2003

(54) Method for providing thermal excitation to molecular dynamics models

(75) Inventor: Erin Sander Catto, Alviso, CA (US)

Correspondence Address: Charles K. Sholtz, Protein Mechanics, Inc., 280 Hope St., Mountain View, CA, 94041, US

(73) Assignee: Protein Mechanics, Inc., Mountain View, CA (US)

(21) Appl. No.: 10/371,187

(22) Filed: Feb. 21, 2003

Related U.S. Application Data
(60) Provisional application No. 60/358,659, filed on Feb. 21, 2002.
(60) Provisional application No. 60/358,637, filed on Feb. 21, 2002.

(51) Int. Cl. G06G 7/48; G06G 7/58

(52) U.S. Cl. 703/11; 703/12

(57) ABSTRACT

Methods for modeling solvent-solute thermal interactions in molecular dynamics simulations are described. The methods, which employ impulses to achieve transfer of thermal energy between solvent and solute, are particularly useful in simulations which make use of an implicit solvent model.

### CROSS-REFERENCES TO RELATED APPLICATIONS

This application is entitled to the benefit of the priority filing date of Provisional Patent Application No. 60/358,659, filed Feb. 21, 2002, Provisional Patent Application No. 60/358,637, filed Feb. 21, 2002, and U.S. patent application Ser. No. ______ , by Michael A. Sherman, et al., titled “A Method for a Geometrically Accurate Model of Solute-Solvent Interactions Using Implicit Solvent”, filed on Feb. 21, 2003, all of which are hereby incorporated by reference.

### BACKGROUND OF THE INVENTION

The present invention is related to the field of molecular modeling and, more particularly, to computer-implemented methods for the dynamic modeling of solute molecules in a solvent environment.

Molecular modeling is concerned with mimicking the behavior of molecules and molecular systems, typically through the use of computers. Molecular modeling applications have included enzyme-ligand docking, molecular diffusion, reaction pathways, phase transitions, and protein folding studies. Researchers in the biological sciences and the pharmaceutical, polymer, and chemical industries are beginning to use these techniques to understand the nature of chemical processes in complex molecules and to design new drugs and materials accordingly.

In molecular dynamics, successive configurations of the molecule or molecular system being modeled are generated by integrating Newton's laws of motion. A molecule, such as a protein, contains multiple bodies (atoms of the molecule or groups of such atoms) whose motions must be considered. Each of these bodies are subject to multiple and complex forces. Thus the calculation of the motion and the shape of the molecule involves the determination of the position and motion of each atom or body of the molecule.

Furthermore, an accurate simulation of the behavior of a selected molecule, such as a peptide or protein, typically needs to account for the effects of the bulk medium, or solvent, which provides the environment for the molecule of interest. The solvent is typically an aqueous liquid, although it may comprise hydrophobic membranes, other organic or inorganic molecules, or mixtures of the above. Solvent properties that one may choose to model include electrostatic screening, cavitation effects, pH, local interactions with other molecules, viscosity, and the provision of a constant-temperature environment. Some or all the solvent's properties may vary spatially, so that the solvent could consist, for example, of an aqueous intracellular region, a hydrophobic membrane region, and an aqueous extracellular region. Temporal changes in solvent properties, such as temperature changes, may also occur.

Molecules interacting within the environment provided by the bulk solvent medium are referred to as the “solute” molecules, or just “solute”. One may choose to model a single solute molecule, such as a protein, or several interacting solute molecules, such as would appear in a protein/ligand or protein/protein interaction. In addition, the model may include an assortment of locally-interacting molecules, such as ions or explicitly modeled water molecules.

Bulk solvent behavior may be simulated in a computer with either an “explicit” or “implicit” solvent model. An explicit model consists of a very large number of individually-modeled solvent molecules, where the positions, orientations and velocities of each explicit molecule are carefully tracked and their interactions with one another as well as with the solute molecules are calculated. To obtain good bulk behavior this way typically requires thousands to hundreds of thousands of individual molecules to be tracked, and is therefore computationally expensive. In fact, the explicit solvent computation is usually the most expensive part of a molecular simulation. Even so, it represents only a small finite region of the effectively-infinite solvent volume, so special treatment is required at the boundaries. Boundary conditions are chosen to account for the long-range effects of the unmodeled portion of the solvent, and to keep the explicit solvent molecules within the desired spatial region. Typically, periodic boundary conditions are used, meaning that the infinite solvent medium is assumed to consist of regularly-repeating volumes with properties identical to the one modeled region.

An implicit solvent model can be considerably more efficient, because it is designed to model the aggregate effects of a bulk solvent's molecules on the solute without modeling the individual solvent molecules. One may include some explicitly-modeled solvent molecules in the system, but they are considered solute molecules and are themselves affected by the bulk solvent medium in which they are embedded. Implicit solvent models can range from simple to complicated, depending on the application and desired fidelity (see, e.g., Cramer and Truhlar, “Implicit Solvation Models: Equilibria, Structure, Spectra, and Dynamics”, Chem. Rev. 99:2161-2200 (1999); and Orozco and Luque, “Theoretical Methods for the Description of the Solvent Effect in Biomolecular Systems”, Chem. Rev. 100:4187-4225 (2000)).

Molecular simulations using implicit solvent models typically contain stochastic terms to account for thermal interactions between the target molecule and the solvent. The Langevin equation is commonly used to represent the effects of molecular collisions on a particle (T. Schick. Molecular Modeling and Simulation: An Interdisciplinary Guide. Springer-Verlag, New York, 2002.), and has been used in the past to eliminate explicit representation of individual solvent molecules (see, e.g., R. W. Pastor. Techniques and applications of Langevin dynamics simulations. In G. R. Luckhurst and C. A. Veracini, editors, The Molecular Dynamics of Liquid Crystals, pages 85-138. Kluwer Academic, Dordrecht, The Netherlands, 1994). The tangevin equation is represented, for one dimensional motion of a particle, as:

\dot{x}=v

m\dot{v}=−mγv+F(x)+R(t) (11)

where m is the particle mass, x is the position, v is the velocity, γ is the damping constant, and F is a deterministic force (usually the negative of the energy gradient). The stochastic force R is a stationary Gaussian process with mean and variance (T. Schick. Molecular Modeling and Simulation: An Interdisciplinary Guide. Springer-Verlag, New York, 2002.):

<R(t)>=0

<R(t)R(t′)>=2mγk_{B}δ(t−t′) (12)

where k_{B} is Boltzmann's constant. The equations of motions for the system may be written as

$$\{ \begin{matrix}\dot{x} \\ \dot{v}\end{matrix} \} = \{ \begin{matrix}v \\ - γ v + \frac{1}{m} F ( x ) + \frac{1}{m} R ( t )\end{matrix} \} \qquad ( 13 )$$

In practice, these equations are solved numerically. A numerical integrator can take this description and initial conditions to advance time by a specified amount. This process yields a new set of initial conditions and the process is repeated as desired. The 2-vector may be defined as:

$$y ( t ) {=}^{Δ} \{ \begin{matrix}x \\ v\end{matrix} \} \qquad ( 14 )$$

One can then generate a sequence such as y(0), y(h), y(2h), . . . where h is the desired time step.

The selection of a suitable integrator depends in part on the damping constant y, which determines the strength of coupling between the molecule being modeled and the solvent environment. At small values of γ, inertial forces dominate; as γ increases, we move to a diffusive regime. Therefore, in cases where γh<<1, one can employ, for example, the numerical integration scheme provided in A. R. Leach. Molecular Modeling: Principles and Applications Second Edition. Addison Wesley Longman Limited, Essex, 2001, page 389:

$$\begin{matrix}{x}_{i + 1} = {x}_{i} + {v}_{i} h + \frac{1}{2} {h}^{2} [ - γ {v}_{i} + \frac{1}{m} ( {F}_{i} + {R}_{i} ) ] \\ {v}_{i + 1} = {v}_{i} + h [ - γ {v}_{i} + \frac{1}{m} ( {F}_{i} + {R}_{i} ) ]\end{matrix} \qquad ( 15 )$$

where the random force Rᵢ is a taken from a Gaussian distribution with a variance 2mγk_{B}T/h. A more complex variation that can generate values of γh is described in van Gunsteren, et al., “Algorithms for Brownian dynamics.” Molecular Physics 45:637-647 (1982). Another approach useful when γh<<1, referred to as the “BBK algorithm”, is described by Brunger, A., et al., “Stochastic boundary conditions for molecular dynamics simulations of ST2 water.” Chem. Phys. Lett. 105:495-500 (1982).

The above schemes are explicit integrators (no relation to explicit solvent models), and therefore limit the size of the time step h than can be taken. Implicit integration approaches, such as Langevin/Implicit-Euler (“LI”) and LI with normal-mode analysis (“LIN”) can be advantageous in that they allow for the possibility of larger timesteps during the integration (see, e.g., Zhang and Schlick (1993) “A new algorithm combining implicit integration and normal mode techniques for molecular dynamics.” J. Comput. Chem. 14:1212-1233; Zhang and Schlick (1994) “The Langevin/implicit-Euler/Normal-Mode scheme (LIN) for molecular dynamics at large time steps.” J. Chem. Phys. 101:4995-5012; and Zhang and Schlick (1995) “Implicit discretization schemes for Langevin dynamics. Mol. Phys. 84:1077-1098).

However, regardless of the type of integrator used, the approaches based on the Langevin equation to model solute-solvent interactions have certain limitations. One limitation is that these methods typically provide no error estimate—an error estimate is important to building an adaptive numerical integrator which can divide h as needed to achieve a specified accuracy. Another limitation is that they involve working with stochastic differential equations (SDEs), which are more difficult to solve numerically than ordinary differential equations (ODEs). Solving stochastic differential equations typically requires using abstract mathematical methods such as Ito calculus (P. E. Kloeden and E. Platen. Numerical Solution of Stochastic Differential Equations. Springer-Verlag, Heidelberg, 1992, p 75). These methods are often far less accurate than methods for solving ordinary differential equations, and are not conducive to error control or implicit integration. Thus, stochastic terms generally preclude the use of more efficient integration schemes that may be implicit and/or use an adaptive time step, and results in smaller time steps and no error control, even when used with implicit integrators. The present invention provides novel methods of modeling such thermal interactions which do not require the solution of stochastic differential equations and can provide effective error estimates during the simulation.

### SUMMARY OF THE INVENTION

In a general aspect, the present invention provides a method for modeling solvent-solute thermal interactions in a molecular dynamics simulation. Steps in the method (which may be evaluated in any computationally-feasible order) include (i) providing a representation of a solute molecule (e.g., as a plurality of connected bodies); (ii) running a molecular dynamics simulation of the solute molecule (e.g., a computer-implemented simulation) where (a) positions and velocities of the bodies are computed at discrete timesteps during the simulation, and (b) the simulation uses an implicit solvent model; (iii) applying one or more impulses to the bodies during the simulation; and (iv) calculating the effect of the impulses on the velocities of the bodies. The effect of the impulses on the velocities of the bodies (which constitute the solute molecule) reflects the solvent-solute thermal interactions in the molecular dynamics simulation. For example, the impulses may be thought of as reflecting the effects of collisions between solvent and solute atoms.

In any embodiment herein, the solvent may be selected, e.g., from the group consisting of an aqueous solvent and an organic solvent. Other examples of solvent include a structured solvent, such as a lipid bilayer, a uniform solvent, and a non-uniform solvent. Furthermore, in any embodiment herein, the solute molecule may be, for example, a polymer, such as a polypeptide, a polynucleotide, polysaccharide, etc., or a small molecule, such as a small organic molecule, e.g., drug, ligand, etc. The method may be used, for example, to model two or more solute molecules simultaneously, e.g., a polypeptide and a small molecule.

In one embodiment, the representation of the solute molecule is formulated in Cartesian coordinates. In another embodiment, the representation is expressed in internal (e.g., torsion angle) coordinates. In yet another embodiment, the bodies comprise individual atoms of the molecule. In still another embodiment, the bodies comprise rigid bodies, each rigid body being formed of a group of individual atoms. The impulses may be applied directionally, or non-directionally.

In one embodiment, the running of the simulation includes the use of an adaptive integrator, or an integrator which includes error control. In another embodiment, the running of the simulation includes the use of an explicit integrator. In yet another embodiment, the running of the simulation includes the use of an implicit integrator. In one embodiment, the running of the simulation does not require solving stochastic differential equations.

In one embodiment, the impulses are applied using a “bulk impulse” model. In another embodiment, the impulses are applied using a “collision impulse” model. In still another embodiment, the applying of impulses is carried out during some, but not all, the discrete timesteps, i.e., such that the thermal transfer does not occur at each “time step” taken by the integrator during the simulation, but rather occurs intermittently, at regular or random intervals. In yet another embodiment, the representation of the solute molecule has a calculated temperature, and the impulses are applied when the temperature is outside a selected range.

In another embodiment, the one or more impulses are generated by simulating a bath particle with a random velocity. In another embodiment, the impulses are generated through use of a random impulse vector. In a related embodiment, the calculating includes computing a discriminant of a quadratic equation.

Also included in the preset invention is method for modeling kinetic behavior of a solute molecule in a solvent. The methods includes, in any computationally-feasible order, (i) running a computer-implemented molecular dynamics simulation of the solute molecule using an implicit solvent model; (ii) simulating solvent-solute thermal interaction by applying one or more impulses to the solute molecule during the running; and (iv) calculating an effect of the impulses on the kinetic behavior of the solute molecule.

The present invention also provides for a computer system and computer code. The computer system preferably includes at least one processor and an associated memory subsystem, where the memory subsystem holds computer code to instruct the at least one processor to carry our any of the methods described herein.

It will be appreciated by one of skill in the art that the embodiments summarized above may be used together in any suitable combination to generate additional embodiments not expressly recited above, and that such embodiments are considered to be part of the present invention.

### BRIEF DESCRIPTION OF THE DRAWINGS

FIG. 1 is a process flowchart showing an overview of the steps used in a typical molecular dynamics simulation;

FIG. 2 is a process flowchart showing an embodiment of the invention implemented in a bulk impulse model.

FIG. 3 is a process flowchart showing an embodiment of the invention implemented in a collision impulse model.

FIG. 4 is a 2-dimensional representation of an atom and a bath particle colliding.

FIG. 5 is a 2-dimensional representation of atoms of a molecule used to illustrate a method of determining whether a point is on a solvent-accessible surface.

FIG. 6 is diagram of a computer system useful for executing methods of the present invention.

FIG. 7 shows a simple molecular system modeled as a pendulum with bath collisions.

FIG. 8 shows the cumulative average temperature of the pendulum of FIG. 7.

### DETAILED DESCRIPTION OF SPECIFIC EMBODIMENTS

I. Definitions

Unless specified otherwise, an “atom” is defined herein as a representation of (i) an elemental atom, or (ii) a “unified” atom, in the modeling method or algorithm under consideration. Such a representation is often, but not always, a sphere. A unified atom refers to a small group of atoms that, for the purposes of molecular modeling & simulation, are treated as a single atomic unit. For example, although a water molecule comprises an oxygen atom and two hydrogen atoms, represented in a space-filling model as a larger sphere with two smaller spheres embedded in it at a characteristic angle relative to one another, the water molecule is often represented in molecular models, simulations & related algorithms as a “unified” spherical atom having a van der Waals radius of 1.4 Angstroms.

A “body”, in the context of a component of a molecule, is defined as a unit of the molecule which is treated as a single mass or geometric structure for purposes of modeling the molecule. Accordingly, a body can be an individual atom of the molecule, a collection of atoms, or other abstract system of masses. A “rigid body” is a body that is modeled as rigid (i.e., it does not deform in response to forces exerted on it).

A “computationally-feasible order” refers to any order in which a particular sequence of tasks can be executed without altering the ultimate result. This concept is invoked, because in some methods, the order of certain steps is not important, so long as the steps are executed and the result is the same as if they were executed in the order originally presented.

An “explicit solvent model” is a model of the effects of solvent in a molecular dynamics simulation that simulates the dynamics of each molecule of the solvent in the vicinity of a solute molecule under study, and does not simulate the effects of the solvent on the solute via bulk solvent properties (with the exception of enforcement of boundary conditions).

A “geometrical object” is any two- or three-dimensional object that can be placed adjacent or mapped onto a sphere. Exemplary geometrical objects are “caps” and “disks”.

An “implicit solvent model” is any model of the effects of solvent in a molecular dynamics simulation that is not an explicit solvent model. Implicit solvent models use at least some bulk solvent properties to represent the effect of the solvent on the solute, but may contain several individual “local” solvent molecules (e.g., in the vicinity of a ligand-binding site on the solute molecule) which are simulated as they would be in an explicit solvent model.

A “non-uniform solvent” is a solvent comprising two or more types of solvent, e.g., an aqueous solvent and an organic solvent. An exemplary non-uniform solvent is a lipid bilayer membrane surrounded by aqueous solvent.

A “polymer” is any organic polymer molecule. Examples of polymers include biopolymers (e.g., polypeptides, polynucleotides and polysaccharides); polymer plastics (e.g., polyethylene, polypropylene, polystyrene, etc.); polymer fluids (e.g., polyethylene glycol, etc.), and the like.

A “representation of a solvent-accessible surface” refers to a set of data which represents the surface of a selected molecule. The data set may include the solvent-accessible surface area (SASA), the spatial location of selected points on the surface, and/or information on the geometric orientation of the surface relative to the molecule. An exemplary representation of a solvent accessible surface is a set of surface normal vectors arranged on atoms of the molecule that are accessible to the solvent.

A “small molecule” refers to any molecule that is not a polypeptides, polynucleotides or polysaccharide, and that has a molecular weight less than about 5 kDa. A small molecule is generally not a polymer, and can be a small organic molecule, a ligand, a lead compound, a drug, a new chemical entity (NCE), etc.

A “solvent” refers to any medium which can contain a solute molecule. Non-limiting examples of a solvent include water & other aqueous solvents, as well as organic solvents (e.g., DMSO, lipids, alcohol, etc.). The solvent may be uniform or non-uniform, and may be in solid, liquid or gaseous form.

A “station point” is a unique location on the surface of, or within a body, that is stationary with respect to that surface or body. A “center point” is a station point that is located at a body's center of mass. Station points are used in defining specific locations on a body which can have defined positions, velocities, accelerations, geometric attributes, charges, etc., and which can be acted on by outside forces to change the body's static or dynamic properties.

II. Overview

Prior art Langevin dynamics approaches for modeling solvent-solute thermal interactions typically employ a stochastic force term, which results in stochastic differential equations and precipitates the problems outlined above. Work performed in support of the present invention demonstrates that it is possible to use a stochastic impulse to model such thermal interactions, without need to use any aspect of the Langevin approach. Using a stochastic impulse simplifies the differential equations and allows them to be solved using standard methods for the numerical solution of ordinary differential equations. Further, this impulse does not need to be derived from a stochastic force and may instead be determined by more fundamental criteria which are described in greater detail below.

The goal of a thermal impulse according to the present invention is to model thermal effects, and not necessarily to approximate the action of a stochastic force. Therefore, the impulse need not be applied during each integration step. Indeed, if desired one may apply the impulse only as necessary to maintain, e.g.,. the temperature of the solvent at a selected value. For example, in an equilibrium simulation of one or more large molecules, the temperature will remain fairly stable and the velocities will have a canonical distribution. Therefore, an impulse may be required infrequently and may be used to, e.g., correct errors introduced by numerical approximations. The method may also be used during a nonequilibrium simulation, where the solute is undergoing large changes in energy and the solvent has a dissipative effect. By applying impulses, the kinetic energy can be regulated during the transition.

A thermal impulse of the invention may be designed simply to adjust the temperature—in this case, it is termed a bulk impulse. Alternatively, in a collision impulse model, the impulse is designed not only to accurately model the temperature, but also to reflect simulated collisions with bath particles, thereby producing a more realistic simulation. However, such bath particles are not tracked or simulated individually (as they would be in an explicit solvent model); rather, they are “created” de novo for each impulse computations.

In a preferred embodiment, the atomic velocities have the correct canonical averages (A. R. Leach. Molecular Modeling: Principles and Applications Second Edition. Addison Wesley Longman Limited, Essex, 2001, p 344). In another embodiment, the directionality of the solvent accessible surface is used to produce a more accurate model—the impulse is directed at random, solvent accessible points created as described below. In another embodiment, although the impulse is stochastic, it is not applied in a totally random manner, but rather at, e.g., regular intervals.

III. Mathematical Overview

The mathematical approach underlying the methods of the invention can be summarized as follows. In a general system with generalized coordinates q and generalized speeds u, the equations of motion can be expressed as:

\dot{q}=B(q)u

M(q)\dot{u}=f(q) (16)

where B is the kinematic matrix, M is the system mass matrix, and f is the vector of generalized forces.

The kinematic matrix B is block diagonal and relates generalized speeds to generalized coordinate derivates. In general, the choice of generalized speeds is arbitrary (see, e.g., T. R. Kane and D. A. Levinson. Dynamics: Theory and Applications. McGraw-Hill, 1985, page 40). In the case of a Cartesian coordinate system this is the identity matrix because the atom positions x, y, and z are used as the generalized coordinates and their derivatives dx|dt, dy|dt, and dz|dt as the generalized speeds.

If one chooses to use torsion angles as generalized coordinates, then the torsion angle derivatives may be used as the generalized speeds, so the kinematic matrix is the identity matrix. To allow a model with torsion coordinates to move freely in the solvent, one needs to choose a base body and assign translation and rotation coordinates to this body. A convenient set of translation coordinates are the Cartesian coordinates and a convenient set of rotation coordinates are Euler parameters. For the generalized speeds of the base body, it is convenient to use the translational and angular velocities. Then the motion of the base body is determined by seven generalized coordinates and six generalized speeds:

$$[ \begin{matrix}\dot{x} \\ \dot{y} \\ \dot{z} \\ {\dot{ϵ}}_{1} \\ {\dot{ϵ}}_{2} \\ {\dot{ϵ}}_{3} \\ {\dot{ϵ}}_{4}\end{matrix} ] = \frac{1}{2} [ \begin{matrix}2 & 0 & 0 & 0 & 0 & 0 \\ 0 & 2 & 0 & 0 & 0 & 0 \\ 0 & 0 & 2 & 0 & 0 & 0 \\ 0 & 0 & 0 & {ϵ}_{4} & - {ϵ}_{3} & {ϵ}_{2} \\ 0 & 0 & 0 & {ϵ}_{3} & {ϵ}_{4} & - {ϵ}_{1} \\ 0 & 0 & 0 & - {ϵ}_{2} & {ϵ}_{1} & {ϵ}_{4} \\ 0 & 0 & 0 & - {ϵ}_{1} & - {ϵ}_{2} & - {ϵ}_{3}\end{matrix} ] [ \begin{matrix}{v}_{x} \\ {v}_{y} \\ {v}_{z} \\ {ω}_{1} \\ {ω}_{2} \\ {ω}_{3}\end{matrix} ] \qquad ( 16 a )$$

The base body translation is [x, y, z]. The Euler parameters are [ε₁, ε₂, ε₃, ε₄]. The translational speed is [vₓ, v_{y}, v_{z}] and the angular speeds are [ω₁,ω₂,ω₃]. See, e.g., H. Goldstein. Classical Mechanics, 2^{nd} Edition. Addison-Wesley, 1980, page 153 regarding Euler parameters.

The mass matrix M and generalized force vector f are computed according to the selected generalized speeds using known methods (see, e.g., Rosenthal, D., PCT Patent Publication WO02/36744, “Method for Residual Form in Molecular Modeling”).

In the case where the force f is impulsive, the second of Eq. 16 is integrated over the duration of the impulse:

$${\int }_{{t}_{0}}^{{t}_{1}} M ( q ) \dot{u} ⅆ t = {\int }_{{t}_{0}}^{{t}_{1}} f ( q ) ⅆ t \qquad ( 17 )$$

The time interval of the impulse is infinitesimally small, so the coordinates may be assumed to be constant. This leads to the impulse-momentum equation:

M(u₁−u₀)=\hat{f} (18)

Here the vector u₀ contains the initial speeds and u₁ contains the final speeds. The vector \hat{f} is the applied impulse, which contains no intermolecular or inertial forces due to their small variation during the impulse.

In a model employing the thermal impulse methods of the invention, a stochastic impulse \hat{f} is thus periodically applied to the system via the impulse-momentum equation to achieve thermal control. The impulse may be modeled, e.g., using Newton's collision law (F. Pfeiffer and C. Glocker. Multibody Dynamics with Unilateral Constraints. John Wiley & Sons, 1996). Newton's collision law is suitable because atomic collisions may be assumed to be frictionless so that the effect of the tangential component of the impulse is zero. Assuming the coefficient of restitution ε is one, the relative velocity after the collision is the negative of the relative velocity before the collision. The magnitude of the impulse is scaled to reach a desired temperature as described in more detail below.

Any suitable numerical integrator may then be used to advance time by time step h (also referred to as δt or Δt). Examples of suitable integrators are described in more detail below. The step size h may selected by the integrator to achieve a satisfactory error level, as is further described below. The next integrator step in the simulation is started with the generalized coordinates from the preceding step, and with generalized speeds which include contributions from the impulse-momentum equation. This process is then repeated as necessary to maintain the solute at the desired temperature.

IV. Molecular Simulations

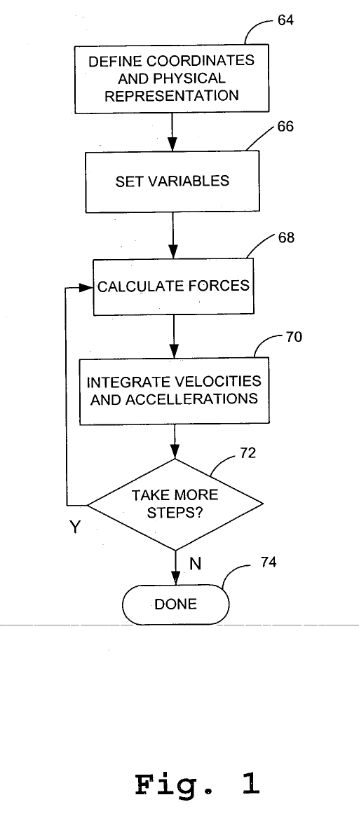

The steps followed in a basic computer-assisted molecular dynamics simulation are known (see, e.g., A. R. Leach. Molecular Modeling: Principles and Applications Second Edition. Addison Wesley Longman Limited, Essex, 2001; Sherman, et al., PCT Patent Application number WO02/39087; and Gronbech-Jensen, et al., U.S. Pat. No. 5,553,004), and are briefly summarized in the flowchart of FIG. 1. The simulation generally begins with a representation of a selected molecular system (typically in a computer usable format) at step 64. The coordinates of the atoms within the representation are specified, either using Cartesian coordinates or a relative coordinate system, such as torsion angle coordinates (see, e.g., Rice and Brunger, Proteins 19:277-290 (1994); Sherman, et al., PCT Patent Application number WO02/39087). Depending on the simulation the atoms in the molecular system may each be modeled as separate entities, or combined into “rigid” or “semi-rigid” bodies (see, e.g., Sherman, et al., PCT Patent Application number WO02/39087; Turner, et al., U.S. Pat. No. 5,424,963), forming a multibody system (MBS).

Once the coordinate system and the physical representation (i.e., individual atoms or MBS) have been defined, the initial variables are set for each atom or body in the representation at step 66, and the interatomic forces acting on each atom of the representation are calculated using any of a number of known techniques at step 68. For example, expressions for the interatomic potential energies between the atom or body under consideration and the other atoms or bodies in the representation may be provided as a function of distance. These expressions may then be differentiated with respect to the distance vectors between the atom or body under consideration and the other atoms or bodies in the representation to give forces. Furthermore, the potential energy and forces may include a solvation model, such as Generalized Born or Poisson-Boltzmann, to account for the dielectric effect of the solvent.

The new positions of the atoms or bodies are determined by numerically integrating the velocity and acceleration expressions at step 70. As discussed below, various numerical integration techniques are suitable for use with the present invention. Eq. 16 may be written in the standard first order form:

$$\frac{ⅆ y}{ⅆ x} = f ( y , x ) \qquad ( 19 )$$

Any method for the integration of ordinary differential equations in the first order form may be used. They include, without limitation, explicit integrators and implicit integrators. Error control may be used in the form of embedded methods and step doubling may be used. Exemplary integrator families include explicit Euler, Runge-Kutta integrators (RADAU5, SDIRK4, DOPRI5), multi-step integrators (DASSL; L. R. Petzold, “A Description of DASSL: A Differential/Algebraic System Solver”, In Proceedings of the 10th IMACS World Congress, Aug. 8-13, 1982 Montreal), Backward Differentiation Formulae (BDF), e.g., Gear's method (Gear, C. W., Numerical Initial Value Problems in Ordinary Differential Equations, Prentice-Hall, 1971.), and predictor-corrector integrators.

After the expressions have been integrated, a decision step 72 determines whether enough steps have been taken to complete the simulation. This might involve, e.g., simply determining whether a predefined number of steps have been achieved (corresponding to a specified length of time). Alternatively, the decision may be based on an evaluation of whether the molecular representation has evolved to a predetermined state (such as adopting a conformation that binds with a ligand, or reaching a certain energy level). Other decision factors may also be considered. If decision step 72 determines that enough steps have been taken, the process is concluded at step 74. If not, the process is repeated based on the new positions & velocities of the atoms or bodies by returning to step 68 and continuing as described above.

V. Determining and Maintaining Temperature

In a molecular system, the temperature is directly related to the kinetic energy of the atoms which constitute the system. In this context, the relationship between kinetic energy and temperature may be expressed as:

$$K E = \frac{1}{2} {k}_{B} T ( 3 N - {N}_{C} ) \qquad ( 20 )$$

where KE is the kinetic energy, k_{B} is Boltzmann's constant, T is the temperature, N is the number of atoms, and N_{C} is the number of constraints.

For a Cartesian formulation, the kinetic energy is summed over all the atoms.

$$K E {=}^{Δ} \frac{1}{2} {\sum }_{i = 1}^{N} {m}_{i} {v}_{i} \cdot {v}_{i} \qquad ( 21 )$$

where m is the mass of an atom and v is its velocity vector.

A comparable expression relating temperature and kinetic energy in torsion space is

$$K E = \frac{1}{2} {k}_{B} T ( 6 + {N}_{U} - {N}_{C} ) \qquad ( 22 )$$

where N_{U} is the number of torsion angles and N_{C} is the number of constraints. This formula assumes the molecule is connected to ground by a free joint (i.e. not constrained to ground). The expression for the kinetic energy in this system is

$$K E = \frac{1}{2} {u}^{T} M u \qquad ( 23 )$$

where u is the array of torsion angle speeds (generalized speeds) and M is the system mass matrix. Alternatively, one may use the generalized speeds to compute the velocity vectors then use the Cartesian formula (Eq. 20) to compute the kinetic energy by calculating atomic velocities and using Eq. 21.

### VI. Bulk Impulse Model

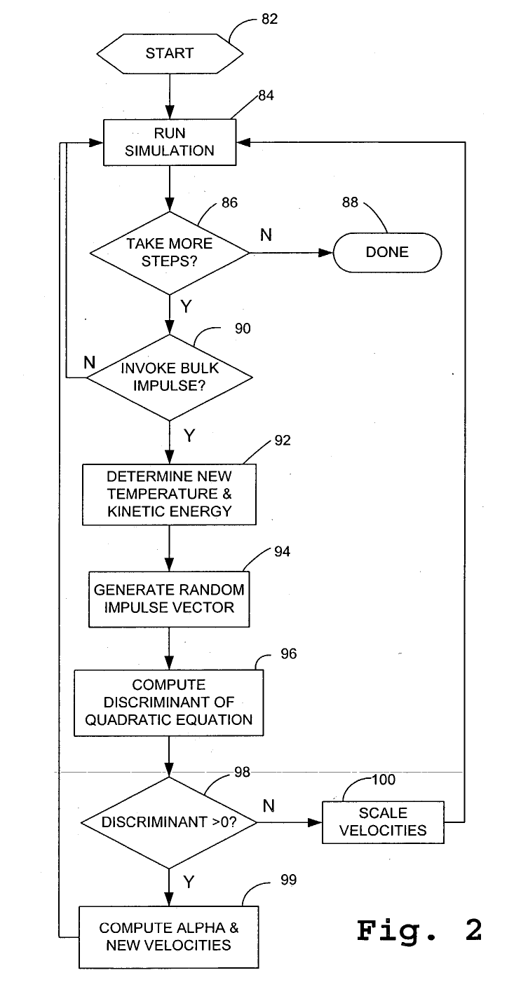

Application of the methods of the invention in a bulk impulse thermal model is described with reference to FIG. 2. The method begins at step 82, by initiating, at step 84, a molecular dynamics simulation, such as the simulation described with reference to FIG. 1. Any suitable iterative molecular dynamics environment can be used to run the simulation, including without limitation, IMAGIRO (Protein Mechanics, Mountain View, Calif.), TINKER (J. Ponder, Washington University School of Medicine, St. Louis, Mo., at http://dasher.wustl.edu/tinker/), GROMACS (http://www.gromacs.org/), AMBER (UCSF, San Francisco, Calif., at http://www.amber.ucsf.edu/amber/amber.html), or NAMD (University of Illinois, Urbana, Ill., at http://www.ks.uiuc.edu/Research/namd/).

As was the case with the general simulation of FIG. 1, a decision is made at each time step during the simulation whether enough steps had been taken (step 86). Assuming the decision at step 86 is not to conclude (step 88), but rather to continue the simulation, a second decision at step 90 is made as to whether to invoke the bulk impulse model. Items which may be factored into the decision of whether to apply an impulse, or invoke the model, include elapsed time, temperature deviation, or it may be decided randomly. For example, one may apply impulses periodically to mimic the thermal interaction with solvent, and check the temperature at any selected point during the simulation to determine if it is within a specified range. Alternatively, the decision may be based on evaluating the temperature of the solute molecule, and applying the impulse if the temperature falls outside a specified range. For example, in a simulation using torsion angle coordinates, the temperature of the molecule is calculated by rearranging Eq. 22:

$$T = \frac{2 KE}{{k}_{B} ( 6 + {N}_{U} - {N}_{C} )} \qquad ( 24 )$$

If the temperature is within a set number of degrees of the threshold (e.g., within 5 degrees), no impulse is applied. If the temperature is outside of this range, a decision 90 is made to apply the impulse.

If decision 90 is affirmative, the desired kinetic energy KE₁ is determined in step 92 by picking a desired temperature. The actual kinetic energy KE₀ is then computed from Eqs. 20 or 22, depending on the coordinate system.

Parameters for calculating the impulse are then determined using one of several approaches. For example, in the embodiment described in step 94, a random impulse vector is generated by expressing \hat{f} as

\hat{f}=αr (25)

where r is a dimensionless vector of real numbers randomly selected from a suitable distribution (e.g., a Gaussian distribution with a unit variance). Other criteria may be applied to the development of the impulse, such as directionality and/or atomic distribution. For example, r may be calculated to represent the velocities of bath molecules by. To include directionality, one would adjust r so that impulses are only applied to the solvent accessible surface (see Section IX—Generating Random Solvent Accessible Points, below). In this case, α would be a positive value. One may query several random points on each atom to find more contributions to r, and may query one or more atoms for each impulse calculation.

The scalar α is computed as described below to achieve a desired kinetic energy, and has units of momentum (mass multiplied by velocity). To determine α, Eq. 25 is substituted into Eq. 18, and the resulting expression rearranged to give:

u₁=u₀+αd (26)

where d is defined by:

dΔM⁻¹r (27)

Then, by substituting Eq. 26 into Eq. 23, one obtains

$$\begin{matrix}{KE}_{1} = \frac{1}{2} {( {u}_{0} + α d )}^{T} M ( {u}_{0} + α d ) \\ = \frac{1}{2} {α}^{2} {d}^{T} Md + α {u}_{0}^{T} Md + {KE}_{0} \\ \end{matrix} \qquad ( 28 )$$

This yields a quadratic polynomial in α:

$$\frac{1}{2} {α}^{2} {d}^{T} Md + α {u}_{0}^{T} Md + {KE}_{0} - {KE}_{1} = 0 \qquad ( 29 )$$

Eq. 29 can be solved for a at step 96 using standard methods as long as the discriminant is non-negative, i.e., as long as:

(u₀^{T}Md)²+2d^{T}Md(KE₁−KE₀)≧0 (30)

Eq. 30 is evaluated at step 98. The discriminant will always be non-negative if the kinetic energy is to be increased, i.e., if the solute was “too cold”. α can be computed if the discriminant is positive or zero. The discriminant may be negative when the kinetic energy should be decreased, depending on r. In this case it is possible to find an r that leads to a positive discriminant. However, it may be more convenient to simply scale the generalized speeds. The velocity is scaled downward at step 100 using the following expression:

$${u}_{1} = \sqrt{\frac{{KE}_{1}}{{KE}_{0}}} {u}_{0} \qquad ( 31 )$$

If the discriminant is positive, then in step 99, Eq. 29 is solved for a real-valued α. The quadratic equation yields 2 solutions—in one embodiment, the solution having the smallest amplitude is selected, because this will lead to a smaller modification of the molecule's generalized speeds. However, the larger solution may also be utilized, for example, when one is trying to rapidly explore all the possible configurations of the molecule. If directionality is being used, then one would choose a positive solution (if one exists) so that impulses are only applied to the solvent accessible surface. Once a is determined, the new generalized speeds are computed using Eq. 26 at step 99.

VII. Collision Impulse Model

A flow chart summarizing the steps involved in applying a collision impulse algorithm is shown in FIG. 3. Steps 102, 104, 106, 108, and 110 are the same as the corresponding steps in FIG. 2. The difference between the two is in how the impulse is computed. In this sense, the collision impulse model is a special case of the bulk impulse model.

In step 112, a first atom of the solute molecule is selected or visited. In step 114 a bath particle with a random velocity is created touching the atom created in step 112. The bath particle has mass m_{b} that is equal to the mass of a solvent particle. Each velocity component in Cartesian space is chosen from a Gaussian distribution with variance chosen in accordance with Eq. 20 and Eq. 21:

$$σ = \sqrt{\frac{{k}_{B} T}{{m}_{b}}} \qquad ( 32 )$$

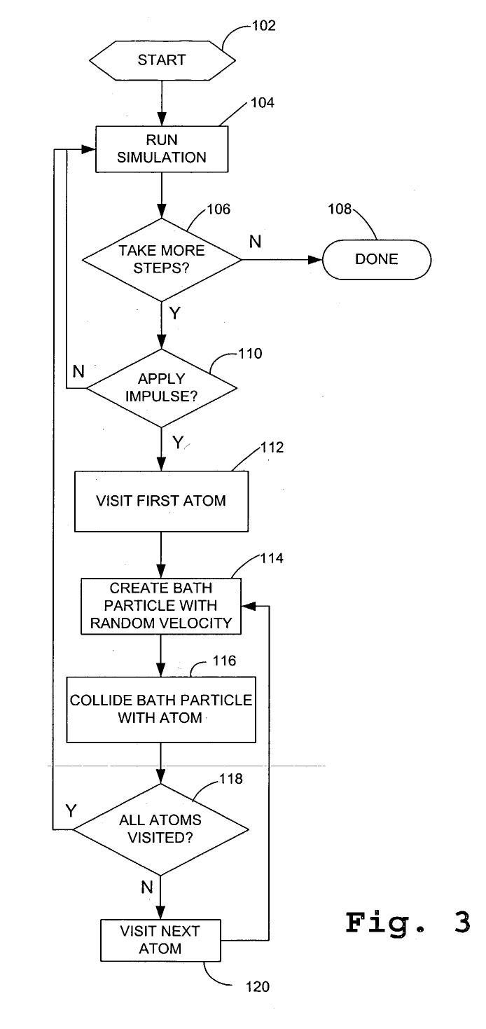

A collision analysis is conducted in step 116 using a fully elastic Newton's collision model. The collision analysis begins by computing the relative velocity of the colliding particles, as illustrated in FIG. 4. The velocity of an atom 122 of the solute molecule is v_{α} and the velocity of a bath particle 124 is V_{b}. At the contact point 126 between the solute atom and bath particle, the surface normal 128 is n. With this data, the relative velocity may be computed as:

Vᵣₑₗ=(v_{b}−v_{α})·n (33)

If the initial relative velocity vᵣₑₗ is non-negative, then no collision occurs. In this case the next bath particle is generated or the simulation proceeds to step 118 in FIG. 3.

During the collision calculation, impulse-momentum balance of Eq. 18 is extended to include the bath particle. The generalized speeds are extend to include the bath particle's velocity:

$$\tilde{u} = [ \begin{matrix}u \\ {v}_{b}\end{matrix} ] \qquad ( 34 )$$

The mass matrix is extended to contain the bath particle's mass:

$$\tilde{M} = [ \begin{matrix}M & 0 \\ 0 & {m}_{b} {I}_{3}\end{matrix} ] \qquad ( 35 )$$

With these definitions, Eq. 18 is extended to contain the bath particle without changing the structure of the formula.

The relative velocity in Eq. 33 may be expressed in terms of the expanded generalized speeds according to a linear relationship:

vᵣₑₗ=W^{T}ũ (36)

Example 1, below, demonstrates an application of matrix W. Assuming that W is already computed, the impulse in term of a Lagrange multipliers λ may be expressed as:

\hat{f}=Wλ (37)

Now Eq. 18 becomes:

\tilde{M}(ũ₁−ũ₀)=Wλ (38)

Eq. 38 is a system of equations equal in number to the size of ũ. This is not a sufficient number of equations to determine the unknowns ũ₁ and λ. The perfectly elastic version of Newton's collision law provides that the final relative velocity is the negative of the initial relative velocity:

vᵣₑₗ¹=−vᵣₑₗ ⁰ (39)

Using Eqs. 36 and 38, one may write:

$$\begin{matrix}{v}_{rel}^{1} - {v}_{rel}^{0} = {W}^{T} ( {\tilde{u}}_{1} - {\tilde{u}}_{0} ) \\ = {W}^{T} {\tilde{M}}^{- 1} W λ \\ = G λ\end{matrix} \qquad ( 40 )$$

For convenience one may introduce the scalar G:

GΔW^{T}\tilde{M}⁻¹W (41)

Using Eq. 39, Eq. 40 may be solved for the Lagrange multiplier:

$$λ = - \frac{2 {v}_{rel}^{0}}{G} \qquad ( 42 )$$

This provides the Lagrange multiplier in terms of known quantities. The final value of the generalized speeds is then computed from Eq. 38:

ũ₁=ũ₀+\tilde{M}⁻¹Wλ (43)

This model provides that the final relative velocity between the solute atom and bath particle is equal in magnitude but of opposite sign to the initial relative velocity. The collision may be assumed to be perfectly elastic so that no energy is lost. In a Cartesian formulation, this will simply modify the velocity of the atom. In a torsion angle formulation, the entire solute molecule's velocity distribution may be affected. This is evident in Eq. 42 because \tilde{M} and W are usually dense matrices. After the collision the bath “particle” is not considered further.

Returning again to FIG. 3, in step 118, it is decided whether all requisite atoms have been visited. One may successively visit all atoms having a surface exposed to solvent, or a subset of such atoms, depending on the degree of realism desired in the simulation. If not enough atoms have been visited, then the next atom is visited in step 120, which continues to step 114 where another bath particle is created. Otherwise, the simulation is continued by integrating Newton's laws of motion as expressed in Eq. 16.

VIII. Error Control in Numerical Integration

Error control is achieved by estimating the error in each time-step (e.g., as detailed below) and then accepting or rejecting the step based on the estimate. Generally, the user will state a priori the desired accuracy and the integrator (if it supports error control) will compare the desired accuracy to the error estimate to determine if the solution is acceptable. Furthermore, an adequate step size may be predicted using the error estimate.

An effective integrator should exert some adaptive control over its own progress, making frequent changes in its step size. Usually the purpose of this adaptive step size control is to achieve some predetermined accuracy in the solution with minimum computational effort. Implementation of adaptive step size control requires that the stepping algorithm signal information about its performance, most important, an estimate of its truncation error. An integrator which is capable of modifying the time step size is referred to herein as an “adaptive” integrator.

Error control can be achieved with any integration method for ordinary differential equations. For example, some integrators have embedded method which provides a low cost, yet accurate, comparison result. If the integrator does not have an embedded method, it is possible to use step doubling to obtain an error estimate. The step doubling method computes the step over one full step and over two half steps and then compares the results.

According to one embodiment of the invention, methods with error control allow an error estimate to be computed using an embedded method of a lower order (see, e.g., J. D. Lambert. Numerical Methods for Ordinary Differential Equations: The Initial Value Problem. John Wiley & Sons, 1991, page 182). For example, one computes two solutions to the differential equation Eq. 16. These solutions have two different orders of accuracy in the time step h. As a. first step, a state variable may be defined as follows:

$$y = \{ \begin{matrix}q \\ u\end{matrix} \} \qquad ( 44 )$$

Using this expression, Eq. 16 may be written as

\dot{y}=g(y) (45)

where

$$g {=}^{Δ} \{ \begin{matrix}Bu \\ {M}^{- 1} f\end{matrix} \} \qquad ( 46 )$$

Eq. 45 expresses Newton's laws as a set of first order ordinary differential equations. If there are the two integrator solutions and the integration method is of order p, then

yₙ₊₁=y(tₙ+h)+O(h^{p+1}) (47)

and the companion method is order p−1:

ŷₙ₊₁=y(xₙ+h)+O(h^{p}) (48)

The companion method may be developed as an embedded method or by step doubling (W. H. Press et al. Numerical Recipes in C++, Second Edition. Cambridge University Press, 2002).

The error estimate is given as:

errΔyₙ₊₁−ŷₙ₊₁ (49)

or

err=O(h^{p}) (50)

So, if one desires to reduce the error by a quantity μ, the expression becomes:

err₍₂₎=μ·err₍₁₎ (51)

Accordingly, one then needs to choose a reduced time-step, such that

h₍₂₎^{p}=μh₍₁₎^{p} (52)

or

h₍₂₎=μ^{1/p}h₍₁₎ (53)

Eq. 53 thus provides a means of adjusting the time step to reduce or increase the error.

In a molecular simulation, error tolerances may be adjusted based on several criteria. There is generally a tradeoff between accuracy and CPU cost. However, this relationship is often nonlinear. Accordingly, it may be preferable to perform numerical experiments with the system of interest, starting with tight tolerances and a high accuracy. Then, to boost performance, the tolerance may be loosened until accuracy diminishes to a unacceptable level. The tolerance may then be tightened again to achieve the most recent acceptable level of accuracy.

Accuracy may be determined using criteria other than the integrator's error estimate. For example, one may monitor energy variations when the system is conservative. This energy should preferably include contributions from both potential and kinetic energy.

IX. Generating Random Solvent Accessible Points

In cases where one wishes to model solute-solvent interactions at discrete locations on the solute surface, e.g., in a collision impulse model, it may be desirable to have the ability of generating random locations on the solute where a solvent molecule can collide with the solute. One suitable method of computing such points is to calculate which regions of the solute are accessible to the solvent (for example, using known methods (e.g., Fraczkiewicz & Braun (1998) J. Comp. Chem. 19:319; Connolly (1983) Journal of Applied Crystallography 16:548; Richmond (1984) Journal of Molecular Biology 178:63; Shrake & Rupley (1973) J. Mol. Biol. 79:351-371 (1973); and Lee & Richards (1971) J. Mol. Biol. 55:379-400), and then pick random points on the solvent-accessible surface (or portions of the surface). However, this approach can be computationally expensive, because it requires a recalculation of the entire solvent accessible surface for each time point at which it is desired to simulate a thermal interaction.

An alternative algorithm, which can provide the same statistical behavior at a much lower computational cost, was therefore developed. According to this method, after an atom is chosen from the molecule being modeled, a point or location on or near the atom's surface is selected. The selected point is then tested to determine if it is inside any other sphere, using, e.g., information obtained from a voxel diagram. If the point is not inside any other sphere, then that location is used. Otherwise the process is repeated.

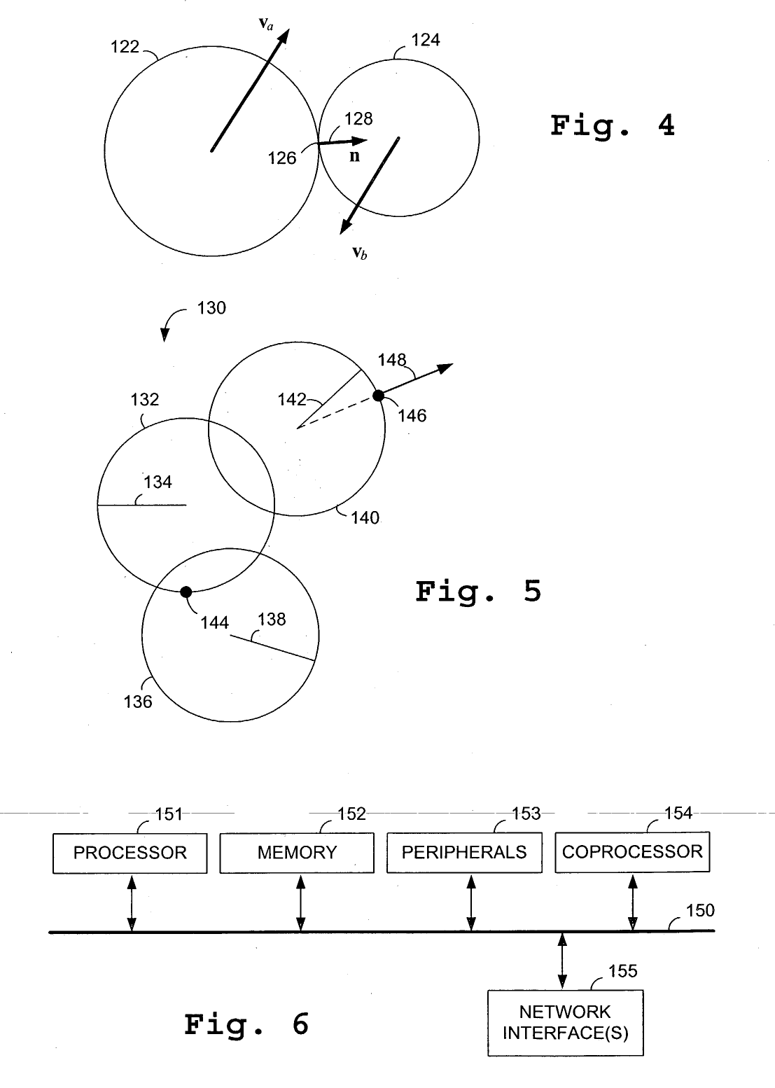

The method is illustrated with reference to FIG. 5. Molecule 130 consists of 3 atoms, represented by Van der Waals surface spheres 132, 136 and 140. The spheres have radii 134, 138 and 142, respectively. A point 144 is randomly generated on sphere 132, and is tested to determine if it resides within any neighboring spheres, e.g., by asking if it is within the radius of any neighboring spheres. A quick calculation determines that it is not within radius 142 of sphere 140, but is within the radius 138 of sphere 136. The process is therefore repeated, and point 146 is generated on sphere 140. A quick calculation determines that point 146 is not within either radius 134 or radius 138, and the point is noted as having a location on the surface of molecule 140. This point may be used to define a surface normal vector 148 perpendicular to the surface of the sphere at point 146.

This approach may be used in a method (e.g., a computer-implemented method) for determining “collision points” or directional solvent-accessible surfaces of an atom. By way of example with continued reference to FIG. 5, point 146 is located on or near the surface of the atom, and surface normal vector 148 is defined at point 146. An assessment is made as to whether point 146 is inside of any of the neighboring atoms (i.e., whether it is inside atoms 132 or 136). Since point 146 is not inside any neighboring atoms, it defines a “collision point”, and surface normal vector 148 at the collision point determines a directional solvent-accessible surface. Although many points may need to be generated and tested, it is an extremely simple and computationally-efficient operation, since it is not necessary to calculate the solvent-accessible surface in order to generate the points.

X. Computer System

To carry out the calculations described above, a computer system may be used with at least one processor and associated memory subsystem for holding the computer code to instruct the processor to perform the operations described above. FIG. 6 illustrates the basic architecture of such a computer system having a processor 151, a memory subsystem 152, peripherals 153 such as input/output devices (keyboard, mouse, display, etc.), perhaps a co-processor 154 to aid in the computations, and network interface devices 155, all interconnected by a bus 150. The memory subsystem optimally includes, in increasing order of access latency, cache memory, main memory and permanent storage memory, such as hard disk drives. Given the amount of intensity of computation, it should be understood that the computer system could include multiple processors with multiple associated memory subsystems to perform the computations in parallel; or, rather than having the various computer elements connected by a bus in conventional computer architecture as illustrated by FIG. 6, the computer system might formed by multiple processors and multiple memory subsystems interconnected by a network.

XI. Industrial Applicability

The approaches described herein are useful in a number of molecular dynamics modeling applications, including long time-scale molecular dynamics modeling where an implicit solvent model is used to increase computational efficiency, and/or where it is desired to take large time steps. Typical existing molecular simulation codes take time steps of about one femtosecond with no error control. The methods described herein allows for time steps to be much greater, often orders of magnitude greater, while maintaining thermal accuracy. Nonlimiting applications of such molecular dynamics simulations include biomolecular structure prediction such as protein, nucleic acid and smaller molecule structures, protein-ligand interaction calculations such as structure and binding affinity, protein-protein interactions and in silico drug lead synthesis and activity determination.

The following example illustrates but in no way is intended to limit the present invention.

### EXAMPLE 1

### Pendulum in Bath

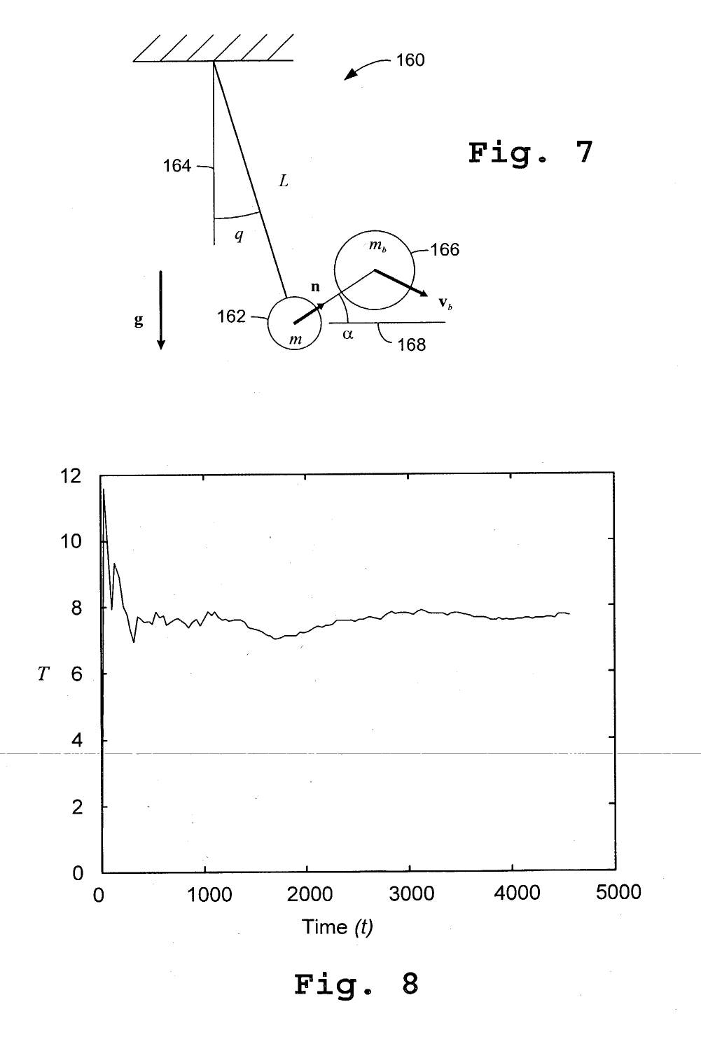

FIG. 7 shows an application of the collision impulse model to a molecular system 160 modeled as a simple pendulum 162 that is subjected to collisions from bath bodies. The pendulum has a length L and mass m. The pendulum makes an angle q with the vertical axis 164 and is subjected to a uniform gravitational field g acting downwards. A typical bath body 166 is shown with mass m_{b} and velocity v_{b}. The pendulum and bath body 166 come into contact at an angle α from the horizontal axis 168. This angle defines the normal vector n.

The equation of motion for pendulum 162 is given by:

\dot{q}=u

mL²\dot{u}+mgL sin q=0 (54)

This equation has the same form as Eq. 16:

B=1

M=mL²

f=−mgL sin q (55)

Eq. 54 is an ordinary differential equation (ODE) since it contains no stochastic terms. The collisions are assumed to be frictionless, and the pendulum tip and bath bodies are assumed to be circular. The radii of the pendulum tip and bath bodies are therefore not relevant to the calculation, and the system is treated as a central impact problem. This means that collisions are resolved at the mass centers of the pendulum tip and bath bodies, and these objects are therefore treated as particles.

The relative velocity is computed in terms of the pendulum angle and speed and the bath particle's speed:

vᵣₑₗ=−uL(cos q cos α+sin q sin α)+v_{bx} cos α+v_{by} sin α (56)

From this, W in Eq. 36 may be expressed as:

$$W = [ \begin{matrix}- L ( cos q cos α + sin q sin α ) \\ cos α \\ sin α\end{matrix} ] \qquad ( 57 )$$

The extended generalized speed vector is formed by concatenating the pendulum speed and bath particle speed:

$$\tilde{u} = [ \begin{matrix}u \\ {v}_{bx} \\ {v}_{by}\end{matrix} ] \qquad ( 58 )$$

Similarly, the extended mass matrix is determined by concatenating the pendulum mass and bath particle mass:

$$\tilde{M} = [ \begin{matrix}m {L}^{2} & 0 & 0 \\ 0 & {m}_{b} & 0 \\ 0 & 0 & {m}_{b}\end{matrix} ] \qquad ( 59 )$$

Eqs. 55, 57, and 59 provide enough information to use Eqs. 42 and 43 to compute the impulse and impulse response.

The pendulum was simulated using the above formulas. The results of the simulation are summarized in FIG. 8, which shows the cumulative average temperature of the pendulum. The instantaneous temperature of the pendulum is computed according to (using Eqs. 21 and 20):

$$T = \frac{m {L}^{2} {u}^{2}}{{k}_{B}} \qquad ( 60 )$$

As the figure shows, the pendulum temperature is very close to the bath temperature of 8. The time solution between collisions was generated using MATLAB® solver ode23 (an explicit, adaptive integrator; The MathWorks, Inc., Natick, Mass.).

While the invention has been described with reference to specific methods and embodiments, it is appreciated that various modifications, changes, alternatives and equivalents may be made and used without departing from the invention. Accordingly, the above description should not be taken as limiting the scope of the invention, which is defined by the metes and bounds of the appended claims.

What is claimed is:

1. A method for modeling solvent-solute thermal interactions in a molecular dynamics simulation, said method comprising
(i) providing a representation of a solute molecule as a plurality of connected bodies;
(ii) running a computer-implemented molecular dynamics simulation of said representation of said solute molecule wherein (a) positions and velocities of said bodies are computed at discrete timesteps during said simulation, and (b) said simulation uses an implicit solvent model;
(iii) applying one or more impulses to one or more of said connected bodies during said running; and
(iv) calculating an effect of said impulses on said velocities of said bodies, wherein said effect of said impulses on said velocities reflects solvent-solute thermal interactions in said molecular dynamics simulation of said solute molecule.

2. A method of claim 1, wherein said modeling includes modeling solvent-solute thermal interactions of two or more solute molecules simultaneously.

3. A method of claim 1, wherein said solvent is selected from the group consisting of an aqueous solvent and an organic solvent.

4. A method of claim 1, wherein said solvent is a lipid bilayer.

5. A method of claim 1, wherein said solvent is a non-uniform solvent.

6. A method of claim 1, wherein said solute molecule is a polymer.

7. A method of claim 6, wherein said solute molecule is selected from the group consisting of a polypeptide, a polynucleotide and a polysaccharide.

8. A method of claim 1, wherein said solute molecule is a small molecule.

9. A method of claim 1, wherein said representation is in Cartesian coordinates.

10. A method of claim 1, wherein said representation is in internal coordinates.

11. A method of claim 10, wherein said representation is in torsion angle coordinates.

12. A method of claim 1, wherein said bodies are representations of individual atoms of said molecule.

13. A method of claim 1, wherein said bodies comprise rigid bodies, each rigid body being formed of a group of individual atoms.

14. A method of claim 1, wherein said running includes use of an explicit integrator.

15. A method of claim 1, wherein said running includes use of an implicit integrator.

16. A method of claim 1, wherein said running includes use of error control.

17. A method of claim 1, wherein said running does not require solving stochastic differential equations.

18. A method of claim 1, wherein said one or more impulses are applied using a bulk impulse model.

19. A method of claim 1, wherein said one or more impulses are applied using a collision impulse model.

20. A method of claim 19, wherein said one or more impulses are applied using a directional collision impulse model.

21. A method of claim 1, wherein said calculating includes scaling the velocities.

22. A method of claim 1, wherein said calculating includes solving a quadratic polynomial in α.

23. A method of claim 1, wherein said representation of said solute molecule has a calculated temperature, and said one or more impulses are applied when said temperature is outside a selected range.

24. A method for modeling kinetic behavior of a solute molecule in a solvent, comprising
(i) running a computer-implemented molecular dynamics simulation of said solute molecule using an implicit solvent model;
(ii) simulating solvent-solute thermal interaction by applying one or more impulses to said solute molecule during said running; and
(iv) calculating an effect of said impulses on the kinetic behavior of said solute molecule.
